(19) United States
(12) Patent Application Publication
(10) Pub. No.: US 2022/0057542 A1
(43) Pub. Date: Feb. 24, 2022

(54) PREDICTING THE IMPACT OF A TROPICAL CYCLONE

(71) Applicant: AccuWeather, Inc., State College, PA (US)

(72) Inventors: Joel N. MYERS, State College, PA (US); Marshall MOSS, State College, PA (US); Jonathan PORTER, State College, PA (US); MIchael ROOT, State College, PA (US)

(73) Assignee: AccuWeather, Inc., State College, PA (US)

(21) Appl. No.: 17/312,781

(22) PCT Filed: Dec. 9, 2019
(86) PCT No.: PCT/US2019/065263

§ 371 Date: Jun. 10, 2021

Related U.S. Application Data
(60) Provisional application No. 62/777,444, filed on Dec. 10, 2018.

(51) Int. Cl. G01W 1/10; G06F 16/29

(52) U.S. Cl. CPC G01W 1/10; G01W 2201/00; G06F 16/29

(57) ABSTRACT

A tropical cyclone analytics system that stores a plurality of ranges for each of a plurality of weather conditions, identifies a forecasted tropical cyclone, identifies a predicted path of the forecasted tropical cyclone, identifies each country or region along the predicted path of the forecasted tropical cyclone, and, for each country or region along the predicted path of the forecasted tropical cyclone, identifies forecasted weather conditions in the country or region attributable to the forecasted tropical cyclone, compares the forecasted weather conditions in the country or region to the plurality of ranges for each of the plurality of weather conditions, characterizes the forecasted tropical cyclone in the country or region based on the comparison of the forecasted weather conditions in the country or region to the plurality of ranges, and outputs the characterization for display to a user.

### CROSS-REFERENCE TO RELATED APPLICATIONS

This application claims priority to U.S. Provisional Patent Application No. 62/777,444, filed Dec. 10, 2018, the entire contents of which is hereby incorporated herein by reference.

### BACKGROUND

A tropical cyclone is a rapidly rotating storm system characterized by a low-pressure center, a closed low-level atmospheric circulation, strong winds, and a spiral arrangement of thunderstorms that produce heavy rain. Depending on its location and strength, a tropical cyclone is referred to by different names, including hurricane, typhoon, tropical storm, cyclonic storm, tropical depression, and (simply) cyclone. Tropical cyclones that occur in the Atlantic Ocean and northeastern Pacific Ocean are generally referred to as “hurricanes.” Tropical cyclones that occur in the northwestern Pacific Ocean are generally referred to as “typhoons.” In the south Pacific or Indian Ocean, comparable storms are generally referred to as “tropical cyclones” or “severe cyclonic storms.”

Tropical cyclones are among the most powerful natural hazards known to humankind. During a tropical cyclone, residential, commercial, industrial, and public buildings—as well as critical infrastructure such as transportation, water, energy, and communication systems—may be damaged or destroyed by several of the impacts associated with tropical cyclones. Wind and water are the twin perils associated with tropical cyclones that, when combined with other natural processes, can be tremendously destructive, deadly and costly.

In addition to impacting individuals, homes, and communities, tropical cyclones also have a profound effect on the environment, especially estuarine and coastal habitats. Tropical cyclones generate strong winds that can completely defoliate forest canopies and cause dramatic structural changes in wooded ecosystems. Animals can either be killed by tropical cyclones or impacted indirectly through changes in habitat and food availability caused by high winds, storm surge, and intense rainfall. Endangered species can be dramatically impacted, such as the Puerto Rican Parrot (Amazona vittata), whose population was reduced to half its original size after the passage of Hurricane Hugo in 1989. Hurricane Gilbert pushed the Cozumel Thrasher (Toxostoma guttatum), found only on Mexico's Isla Cozumel, to the edge of extinction in 1988.

Various storm components associated with tropical cyclones (e.g., storm surge, expansive waves, and landslides) can move large amounts of soil and ultimately reshape the coastal landscape. Hurricanes such as Ivan (2004), Katrina and Rita (2005), and Gustav and Ike (2008), have led to shoreline position changes of about 100 m (328 ft.) in some regions. The loss of land from Hurricanes Katrina and Rita alone was estimated to be about 73 square miles.

By changing environmental conditions in coastal habitats, tropical cyclones cause a cascade of direct and indirect ecological responses that range from immediate to long-term. In terms of environmental effects, no two tropical cyclones are alike. Individual characteristics, such as the storm's forward speed, size, intensity, and amount of precipitation, play a large role in the type and temporal extent of a tropical cyclone's impact. Depending on many of these factors, even tropical storms can cause loss of life and severe damage to property and infrastructure.

The Saffir-Simpson Hurricane Wind Scale (SSHWS) is a tool used by meteorologists to measure the intensity of tropical cyclones. Similar to the Enhanced Fujita Scale used to measure tornadoes, the SSHWS divides tropical cyclones into categories based on the sustained wind speeds during the storm.

To be classified as a hurricane, a tropical cyclone must have one-minute maximum sustained winds of at least 74 mph (33 m/s; 64 kts; 119 km/h). The classifications range from Category 1 to Category 5 based on the maximum sustained wind speeds, as follows:

Saffir-Simpson Scale

| | Wind speeds (for 1-minute maximum sustained winds) | | | |
|---|---|---|---|---|
| Category | m/s | knots (kts) | mph | km/h |
| 1 | 33-42 m/s | 64-82 kts | 74-95 mph | 119-153 km/h |
| 2 | 43-49 m/s | 83-95 kts | 96-110 mph | 154-177 km/h |
| 3 | 50-58 m/s | 96-112 kts | 111-129 mph | 178-208 km/h |
| 4 | 58-70 m/s | 113-136 kts | 130-156 mph | 209-251 km/h |
| 5 | ≥70 m/s | ≥137 kts | ≥157 mph | ≥252 km/h |

Unfortunately, utilizing only current and forecasted wind speed as an indicator of the true damage, disruptive, and life-threatening potential of a tropical cyclone has been shown to be inaccurate and imprecise when reviewing the historical record. As such, wind speed alone is inadequate when attempting to convey to the public, government officials, and first responders the possible effects from, for example, storm surge, flooding, and soil mass wasting (landslides, etc.). Additionally, wind speed alone cannot account for the financial impact from a tropical cyclone. Other variables associated with the storm and natural processes in the storm's projected pathway need to be considered to accurately and precisely articulate the true, potential damage, disruptive, and financial impact from tropical cyclones.

Accordingly, there is a need for a system and method that characterizes forecasted tropical cyclones more accurately and precisely than the prior art method, which takes into account only the wind speed of each storm. Additionally, there is a need for a process that uses mathematical rules rather than humans making subjective determinations. By providing a more complete picture of the potential damage and disruption of a current or forecasted storm, the disclosed system and method provides more information for government officials, first responders, and the general public and enables better decision making at critical times before and during a tropical cyclone. All of these benefits help save lives and limit potential damage to property.

### SUMMARY

In order to overcome those and other drawbacks in the prior art, a tropical cyclone analytics system is provided that stores a plurality of ranges for each of a plurality of weather conditions, identifies a forecasted tropical cyclone, identifies a predicted path of the forecasted tropical cyclone, identifies each country or region along the predicted path of the forecasted tropical cyclone, and, for each country or region along the predicted path of the forecasted tropical cyclone, identifies forecasted weather conditions in the country or region attributable to the forecasted tropical cyclone, compares the forecasted weather conditions in the country or region to the plurality of ranges for each of the plurality of weather conditions, characterizes the forecasted tropical cyclone in the country or region based on the comparison of the forecasted weather conditions in the country or region to the plurality of ranges, and outputs the characterization for display to a user.

The tropical cyclone analytics system may further store a plurality of ranges for a predicted effect of forecasted tropical cyclones, determine one or more demographic characteristics of the geographic area in the predicted path of the forecasted tropical cyclone, predict the effect of the forecasted tropical cyclone in the country or region based on one or more of the forecasted weather conditions attributable to the forecasted tropical cyclone and the one or more demographic characteristics of the geographic area in the predicted path of the forecasted tropical cyclone, and compare the predicted effect of the forecasted tropical cyclone in the country or region to the plurality of ranges for a predicted effect. In those embodiments the characterization of the forecasted tropical cyclone in the country or region is further based on the comparison of the predicted effect of the forecasted tropical cyclone in the country or region to the plurality of ranges for a predicted effect.

The tropical cyclone analytics system may further determine one or more geographical or geological characteristics of the geographic area in the predicted path of the forecasted tropical cyclone. In those embodiments, the predicted effect of the forecasted tropical cyclone is predicted further based on the one or more geographical or geological characteristics of the geographic area in the predicted path of the forecasted tropical cyclone.

In some embodiments, the predicted effect of the forecasted tropical cyclone may be the predicted economic impact of the forecasted tropical cyclone. In those embodiments, the predicted economic impact of the forecasted tropical cyclone is estimated by identifying the economic impact of past tropical cyclones, identifying the size of each economy impacted by each of the past tropical cyclones, scaling the economic impact based on the size of the impacted economy at the time of each past tropical cyclone, identifying weather conditions of each of the past tropical cyclones, determining correlations between the scaled economic impact of each of the past tropical cyclones and the past weather conditions of each of the past tropical cyclones, and generating a model estimating the economic impact of tropical cyclones based on the correlations between the scaled economic impact of each of the past tropical cyclones and the past weather conditions of each of the past tropical cyclones. In those embodiments, the model estimating the economic impact of tropical cyclones may be generated further based on correlations between the scaled economic impact of each of the past tropical cyclones and demographic or geographical or geological characteristics of the geographic area affected by each of the past tropical cyclones.

In any of the foregoing embodiments, the comparison of the forecasted weather conditions to the plurality of ranges and the characterization of the forecasted tropical cyclone based on the comparison may be performed by a hardware computer processor without human intervention.

All of the aforementioned embodiments provide important technical and public safety benefits when compared to the existing method (the Saffir-Simpson Hurricane Wind Scale), which relies only on the forecasted maximum sustained wind speed. By characterizing each tropical cyclone based on multiple forecasted weather conditions (and, in some embodiments, characteristics of the geographic area in the predicted path of the forecasted tropical cyclone), the tropical cyclone analytics system is be able to more accurately predict—and more completely convey—the threat to life and property posed by a forecasted tropical cyclone.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments, wherein:

FIG. 1 is a block diagram illustrating a tropical cyclone analytics system 100 according to an exemplary embodiment of the present invention;

FIG. 2 is a drawing illustrating an overview of the architecture of the tropical cyclone analytics system according to exemplary embodiments of the present invention;

FIG. 3 is a flowchart illustrating a process for modeling the past economic impact of past tropical cyclones according to exemplary embodiments of the present invention;

FIG. 4 is a flowchart illustrating a process for characterizing the threat posed by each current or forecasted tropical cyclones according to exemplary embodiments of the present invention;

FIG. 5 is a view of a graphical user interface outputting a characterization of a forecasted tropical cyclone for display to a user according to exemplary embodiments of the present invention; and

FIG. 6 is another view of a graphical user interface outputting a characterization of a forecasted tropical cyclone for display to a user according to exemplary embodiments of the present invention.

### DETAILED DESCRIPTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

### System Architecture

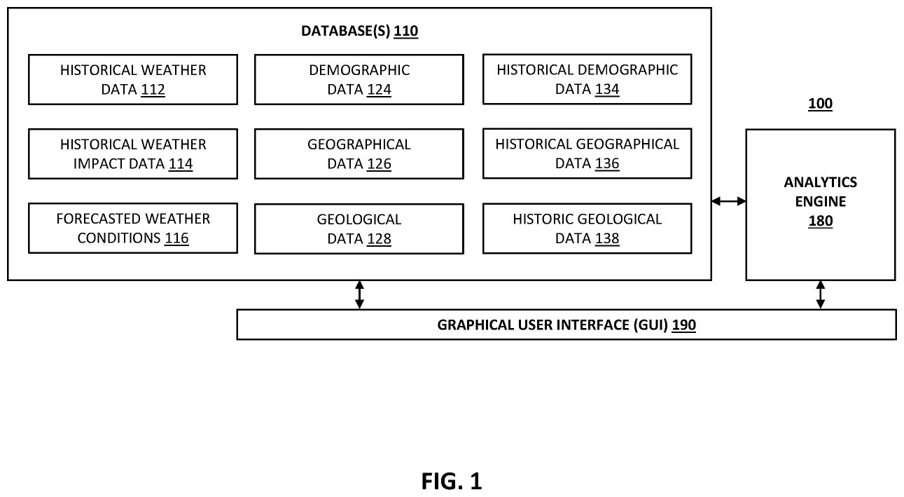

FIG. 1 is a block diagram illustrating a tropical cyclone analytics system 100 according to an exemplary embodiment of the present invention.

As shown in FIG. 1, the tropical cyclone analytics system 100 includes one or more databases 110, an analytics engine 180, and a graphical user interface 190. The one or more databases 110 include historical weather data 112, historical weather impact data 114, and forecasted weather conditions 116. Additionally, the one or more databases 110 may include demographic data 124, geographical data 126, and/or geological data 128. In some embodiments, the one or more databases 110 may also include historical demographic data 134. In some embodiments, the one or more databases 110 may additionally include historical geographical data 136, and historical geological data 138.

The historical weather data 112 includes information indicative of the path and time of past tropical cyclones. For each of the past tropical cyclones, the historical weather data 112 also includes information indicative of the severity of each past tropical cyclone as measured by a number of individual weather conditions that occurred due to that past tropical cyclone. For each past tropical cyclone, for example, the historical weather data 112 may include information indicative of the wind speed (e.g., the maximum sustained wind speed), the rainfall (e.g., the total accumulated rainfall caused by the past tropical cyclone, the maximum rainfall per day caused by the past tropical cyclone, etc.), the storm surge, the coastal inundation, the accumulated cyclone energy (ACE), the surface pressure, the high temperature, the low temperature, etc. The historical weather data 112 may be received from publicly-available sources (e.g., the National Oceanic and Atmospheric Administration (NOAA) Storm Events Database), private sources (e.g., AccuWeather, Inc., AccuWeather Enterprise Solutions, Inc.), etc.

The historical weather impact data 114 includes information indicative of the economic impact of each of the past tropical cyclones. The economic impact of each of the past tropical cyclones may include the direct damage to property and crops as well as indirect disruption attributable to the past tropical cyclones (e.g., power outages, lost sales, shipment delays data, reduced consumer spending, reduced visits to retail and service locations, augmented traffic speeds, etc.). The historical weather impact data 114 may be received from publicly-available sources, such as the NOAA Storm Events Database (which aggregates information from county, state and federal emergency management officials), local law enforcement officials, skywarn spotters, National Weather Service (NWS) damage surveys, newspaper clipping services, the insurance industry, the general public, etc.), information from industry-specific commercial and non-commercial entities (e.g., insurance claim information), third party sources, etc. The analytics engine 180 may also use an economic forecasting model, such as the model developed by Solomon M. Hsiang and Amir S. Jina, to estimate the effect of each past tropical cyclone on long-run economic growth (see, e.g., Hsiang, et al., The Causal Effect of Environmental Catastrophe on Long-Run Economic Growth: Evidence From 6,700 Cyclones, NBER Working Paper No. 20352, July 2014). The tropical cyclone analytics system 100 may also use client-specific data (received from a client) to determine client-specific impacts of past tropical cyclones.

The demographic data 124 may include, for example, population density, population age levels, population education levels, income levels, family size, and/or concentrations of real estate sectors (residential, commercial, and industrial) per unit area of geographic areas (e.g., geographic areas in the projected paths of forecasted tropical cyclones). Information indicative of those demographic components may be received, for example, from one or more third parties, such as the United States Census Bureau, the World Bank, etc. As described below, the tropical cyclone analytics system 100 may also utilize the demographics of the geographic areas in the paths of past tropical cyclones to model the effect of past tropical cyclones (and use that model to forecast the effect of forecasted tropical cyclones). Because the demographics of geographic areas may have shifted over time, the tropical cyclone analytics system 100 may also store historical demographic data 134 indicative of the demographics of the geographic areas in the paths of past tropical cyclones. That historical demographic data 134 may similarly be received from third parties (e.g., the United States Census Bureau, the World Bank, etc.) or may be estimated based on the information currently available.

The geographical data 126 may include, for example, information indicative of the topography, terrain slope, and/or terrain orientation of geographic areas (i.e., geographic areas in the paths of past tropical cyclones and geographic areas in the forecasted paths of forecasted tropical cyclones). The geographical data 126 may be received from a third party. The geographical data 126 may be determined, for example, based on imagery from Synthetic-aperture radar (SAR), Landsat satellites, etc. If it is determined that the topography, terrain slope, and/or terrain orientation of geographic has meaningfully shifted over time, the tropical cyclone analytics system 100 may also store historical geographical data 136 indicative of the topography and/or terrain of the geographic areas in the paths of past tropical cyclones. That historical demographic data 136 may similarly be received from third parties, determined based on past imagery, or estimated based on the information currently available.

The geological data 128 may include information indicative of the nature and exposure of bedrock, soil type, soil stability data, and location-specific seismicity of geographic areas (i.e., geographic areas in the paths of past tropical cyclones and geographic areas in the forecasted paths of forecasted tropical cyclones). The geological data 128 may be received from one or more third parties, such as the United States Geological Survey (USGS), the Natural Resources Conservation Service (NRCS), the United States Department of Agriculture (USDA), etc. If it is determined that the geologic conditions of geographic areas have meaningfully shifted over time, the tropical cyclone analytics system 100 may also store historical geological data 138 indicative of the geological characteristics of the geographic areas in the paths of past tropical cyclones. That historical geological data 138 may similarly be received from third parties, estimated based on the information currently available, etc.

The forecasted weather conditions 116 include information indicative of the predicted location, predicted time, and predicted magnitude of the forecasted weather conditions associated with forecasted tropical cyclones. The forecasted weather conditions 116 may include wind speed (e.g., the maximum sustained wind speed), rainfall (e.g., total accumulated rainfall, maximum rainfall per day, etc.), storm surge, coastal inundation, accumulated cyclone energy, surface pressure, high temperature, low temperature, etc. The forecasted weather conditions 116 and events may be received from AccuWeather, Inc., AccuWeather Enterprise Solutions, Inc., the National Weather Service (NWS), the National Hurricane Center (NHC), other governmental agencies (such as Environment Canada, the U.K. Meteorologic Service, the Japan Meteorological Agency, etc.), private companies (such as Weather Decision Technologies, Inc.), etc. The forecasted weather conditions 116 may be determined using a numerical weather prediction model (or ensemble of models) of the atmosphere and oceans to predict the weather based on current weather conditions.

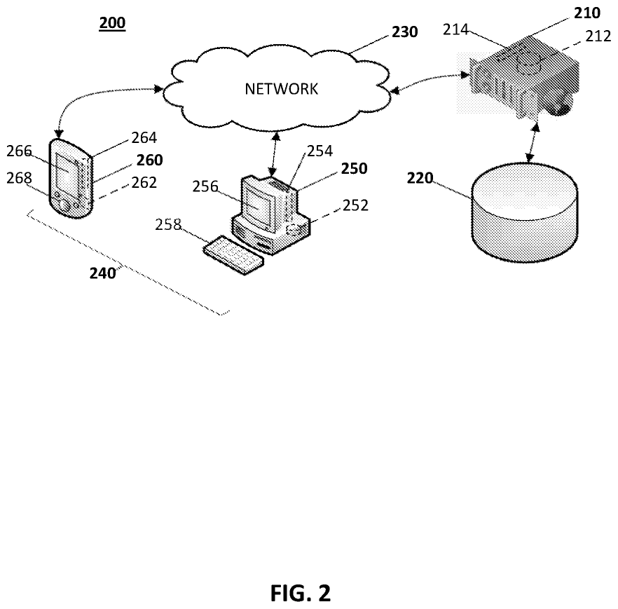

FIG. 2 is a drawing illustrating an overview of the architecture 200 of the tropical cyclone analytics system 100 according to exemplary embodiments of the present invention.

As shown in FIG. 2, the architecture 200 may include one or more servers 210 and one or more storage devices 220 connected to a plurality of remote computer systems 240, such as one or more personal systems 250 and one or more mobile computer systems 260, via one or more networks 230.

The one or more servers 210 may include an internal storage device 212 and a processor 214. The one or more servers 210 may be any suitable computing device including, for example, an application server and a web server which hosts websites accessible by the remote computer systems 240. The one or more storage devices 220 may include external storage devices and/or the internal storage device 212 of the one or more servers 210. The one or more storage devices 220 may also include any non-transitory computer-readable storage medium, such as an external hard disk array or solid-state memory. The networks 230 may include any combination of the internet, cellular networks, wide area networks (WAN), local area networks (LAN), etc. Communication via the networks 230 may be realized by wired and/or wireless connections. A remote computer system 240 may be any suitable electronic device configured to send and/or receive data via the networks 230. A remote computer system 240 may be, for example, a network-connected computing device such as a personal computer, a notebook computer, a smartphone, a personal digital assistant (PDA), a tablet, a notebook computer, a portable weather detector, a global positioning satellite (GPS) receiver, network-connected vehicle, a wearable device, etc. A personal computer system 250 may include an internal storage device 252, a processor 254, output devices 256 and input devices 258. The one or more mobile computer systems 260 may include an internal storage device 262, a processor 264, output devices 266 and input devices 268. An internal storage device 212, 252, and/or 262 may include one or more non-transitory computer-readable storage mediums, such as hard disks or solid-state memory, for storing software instructions that, when executed by a processor 214, 254, or 264, carry out relevant portions of the features described herein. A processor 214, 254, and/or 264 may include a central processing unit (CPU), a graphics processing unit (GPU), etc. A processor 214, 254, and 264 may be realized as a single semiconductor chip or more than one chip. An output device 256 and/or 266 may include a display, speakers, external ports, etc. A display may be any suitable device configured to output visible light, such as a liquid crystal display (LCD), a light emitting polymer display (LPD), a light emitting diode display (LED), an organic light emitting diode display (OLED), etc. The input devices 258 and/or 268 may include keyboards, mice, trackballs, still or video cameras, touchpads, etc. A touchpad may be overlaid or integrated with a display to form a touch-sensitive display or touchscreen.

Referring back to FIG. 1, the one or more databases 110 may be any organized collection of information, whether stored on a single tangible device or multiple tangible devices, and may be stored, for example, in the one or more storage devices 220. The analytics engine 180 may be realized by software instructions stored on one or more of the internal storage devices 212, 252, and/or 262 and executed by one or more of the processors 214, 254, or 264. The graphical user interface 190 may be any interface that allows a user to input information for transmittal to the tropical cyclone analytics system 100 and/or outputs information received from the tropical cyclone analytics system 100 to a user. The graphical user interface 190 may be realized by software instructions stored on one or more of the internal storage devices 212, 252, and/or 262 and executed by one or more of the processors 214, 254, or 264.

### Modeling the Impact of Past Tropical Cyclones

In order to characterize the threat posed by current and forecasted tropical cyclones, the system may predict the economic impact of each current and forecasted tropical cyclone. To date, the economic impact of current and forecasted weather events has been estimated by humans making subjective determinations (e.g., meteorologists, climatologists, economists etc.). Those subjective determinations, however, have a number of drawbacks. In addition to the increased time it takes for a person (or a group of people) to make those subjective determinations, those subjective determinations are also inconsistent because they are dependent on the skill level and dispositions of the person (or people) making those determinations. In order to overcome those disadvantages in the prior art, the tropical cyclone analytics system 100 may employ specific mathematical rules to predict the estimated economic impact of each current and forecasted tropical cyclone. The tropical cyclone analytics system 100 may identify those mathematical rules by modeling the past economic impact of past tropical cyclones.

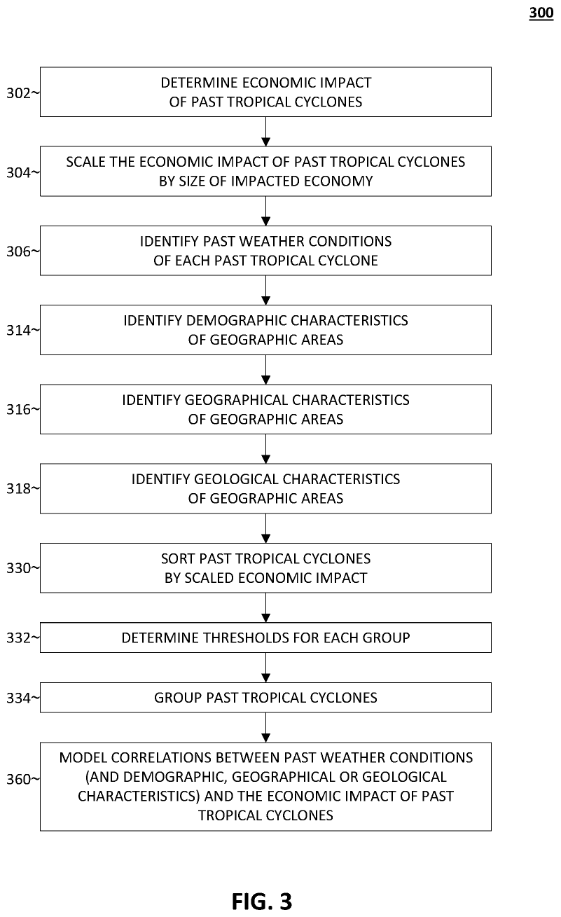

FIG. 3 is a flowchart illustrating a process 300 for modeling the past economic impact of past tropical cyclones according to exemplary embodiments of the present invention. The modeling process 300 may be performed by the one or more servers 210 executing the analytics engine 180. As described below, some operations included in the modeling process 300 may be optional and included in only some of the embodiments of the tropical cyclone analytics system 100. Additionally, as one of ordinary skill in the art would recognize, the operations in the modeling process 300 do not necessarily need to be performed in the order they are shown in FIG. 3 and described below.

The economic impact of past tropical cyclones is identified in step 302. As mentioned above, the historical weather impact data 114 stored in the one or more databases 110 includes information indicative of the economic impact of past tropical cyclones. The economic impact of each of the past tropical cyclones may include the direct damage to property and crops as well as indirect disruption attributable to the past tropical cyclones (e.g., power outages, lost sales, shipment delays data, reduced consumer spending, reduced visits to retail and service locations, augmented traffic speeds, etc.). The economic impact of each of the past tropical cyclones may also include the effects of each past tropical cyclone on long-run economic growth as determined using an economic forecasting model, such as the model developed by Solomon M. Hsiang and Amir S. Jina (see, e.g., Hsiang, et al., The Causal Effect of Environmental Catastrophe on Long-Run Economic Growth: Evidence From 6,700 Cyclones, NBER Working Paper No. 20352, July 2014).

Tropical cyclones are dynamic weather events with characteristics that change as the storm moves along its path. The sustained winds in a tropical cyclone, for example, typically increase as the storm gathers over an ocean and then dissipate as the storm moves across the sea and/or land. If a tropical cyclone makes landfall in two different regions (or countries) in two different periods during its lifespan, then the same tropical cyclone will cause very different weather conditions (and have very different economic impacts) in those locations. In fact, the economic impact of a tropical cyclone in one country or region may be entirely unrelated to the weather conditions of that tropical cyclone when that tropical cyclone made landfall in another country or region. Accordingly, the tropical cyclone analytics system 100 may treat tropical cyclones that make landfall in two different regions or countries as two separate storms and may separately store the weather conditions (and economic impact) of that tropical cyclone in the first country or region and the weather conditions (and economic impact).

The economic impacts of past tropical cyclones (identified in step 302) are scaled based on the size of the impacted economy at the time of each past tropical cyclone in step 304. Such past tropical cyclones occurred in different locations and at different times in the past. The economic impacts of those past tropical cyclones are likely to have varied significantly based on the size of the economy in the affected geographic area during the affected time period. Meanwhile, the purpose of the process 300 is to model the economic impact of the weather conditions attributed to the past tropical cyclones regardless of when and where those past tropical cyclones made landfall. Accordingly, the economic impacts of past tropical cyclones are scaled based on the size of the impacted economy at the time of each past tropical cyclone to control for the size of the impacted economy and isolate the economic impact attributable to the past weather conditions of the past tropical cyclones.

The weather conditions of the past tropical cyclones are identified in step 306. As mentioned above, the historical weather data 112 included in the one or more databases 110 includes information indicative of the severity of each past tropical cyclone as measured by a number of individual weather conditions that occurred due to that past tropical cyclone. For each past tropical cyclone, for example, the historical weather data 112 may include information indicative of the wind speed (e.g., the maximum sustained wind speed), the rainfall (e.g., the total accumulated rainfall caused by the past tropical cyclone, the maximum rainfall per day caused by the past tropical cyclone, etc.), the storm surge, the coastal inundation, the accumulated cyclone energy (ACE), the surface pressure, the high temperature, the low temperature, etc. The historical weather data 112 may be received from publicly-available sources (e.g., the National Oceanic and Atmospheric Administration (NOAA) Storm Events Database), private sources (e.g., AccuWeather, Inc., AccuWeather Enterprise Solutions, Inc.), etc.

The demographic characteristics of the geographic area affected by each of the past tropical cyclones may be identified in step 314. Even when scaled based on the size of the affected economy at the time of each past tropical cyclone, the tropical cyclone analytics system 100 may determine that the economic impact of past tropical cyclones was dependent on one or more of the demographic characteristics of the affected geographic area. As mentioned above, the demographic data 124 stored in the one or more databases 110 may include, for example, population density, population age levels, population education levels, income levels, family size, and/or concentrations of real estate sectors (residential, commercial, and industrial) per unit area of the geographic areas in the paths of past tropical cyclones. If available, the tropical cyclone analytics system 100 may instead utilize the past demographic characteristics (during the time period of each past tropical cyclone) stored in the one or more databases 110 as historical demographic data 134.

The geographical characteristics of the geographic area affected by each of the past tropical cyclones may be identified in step 316. As mentioned above, the geographical data 126 stored in the one or more databases 110 may include, for example, information indicative of the topography, terrain slope, and/or terrain orientation of the geographic areas in the paths of past tropical cyclones. If available, the tropical cyclone analytics system 100 may instead utilize the past geographical characteristics (during the time period of each past tropical cyclone) stored in the one or more databases 110 as historical geographical data 136.

The geological characteristics of the geographic area affected by each of the past tropical cyclones may be identified in step 316. As mentioned above, the geological data 128 stored in the one or more databases 110 may include, for example, information indicative of the nature and exposure of bedrock, soil type, soil stability data, and location-specific seismicity of the geographic areas in the paths of past tropical cyclones. If available, the tropical cyclone analytics system 100 may instead utilize the past geological characteristics (during the time period of each past tropical cyclone) stored in the one or more databases 110 as historical geological data 138.

In step 360, correlations are determined between the scaled economic impact of each of the past tropical cyclones (determined in step 304) and the past weather conditions of each of the past tropical cyclones (determined in step 306) and, in some embodiments, the demographic characteristics of the affected geographic area (determined in step 314), the geographical characteristics of the affected geographic area (determined in step 316), and/or the geological characteristics of the affected geographic area (determined in step 318). In order to determine those correlations, the analytics engine 180 may employ a form of artificial intelligence (e.g., a machine learning algorithm) to use the data set described above as training data to identify correlations without being programmed with explicit instructions for how to determine those correlations. The analytics engine 180 may employ any statistical modeling technique in order to identify the correlations between the scaled economic impact of each past tropical cyclone and the past weather conditions and other independent variables. For example, the analytics engine 180 may use a regression algorithm for the scaled economic impact Y (dependent variable) using multiple regressors (independent variables) following the equation

Y=β₀+β₁X₁+β₂X₂+ . . . +βₖXₖ, where
where Xₖ are k number of predictor variables (e.g., weather conditions, demographic characteristics, geographical characteristics, and/or geological characteristics); and
βₖ are regression coefficients determined by the analytics engine 180 based on the correlations between the predictor variables Xₖ and the scaled economic impact Y of the past tropical cyclones.

Alternatively, the tropical cyclone analytics system 100 may group the past tropical cyclones based on the severity of each past tropical cyclone (as determined by the scaled economic impact of each storm) and then identify past weather conditions (and, optionally, other independent variables) that are correlated with the tropical cyclones in each group. In those embodiments, the past tropical cyclones are sorted by scaled economic impact in step 330, and thresholds are established in step 332 such that the past tropical cyclones are separated into groups in step 334.

In the embodiments where the past tropical cyclones are grouped based on severity, the analytics engine 180 in step 360 uses statistical modeling to identify past weather conditions (and, optionally, other independent variables) that are correlated with the past tropical cyclones having a scaled economic impact within the range of each group. In a preferred embodiment, for each independent variable found to be significantly predictive of the economic impact of the tropical cyclone, the analytics engine 180 identifies a series of ranges wherein each range is correlated with the economic impact of the tropical cyclone being included in each group.

For example, the following chart groups tropical cyclones based on economic impact in 2019 U.S. dollars and independent variables (in this instance, average rainfall, maximum sustained winds, and storm surge) that the analytics engine 180 may determine to be predictive of tropical cyclones having an economic impact within those groups.

| | | Average | Max. Sustained Wind | |
|---|---|---|---|---|
| Economic Impact | | Rainfall | Speed | Storm Surge |
| <$1 | billion | <3 inches | <74 miles per hour | <3 feet |
| $1-10 | billion | 3-8 inches | 74-95 miles per hour | 3-6 feet |
| $10-39 | billion | 8-15 inches | 96-110 miles per hour | 6-10 feet |
| $40-99 | billion | 15-22 inches | 111-129 miles per hour | 10-15 feet |
| $100-199 | billion | 22-30 inches | 130-156 miles per hour | 15-20 feet |
| $200+ | billion | >30 inches | >156 miles per hour | >20 feet |

Some of the independent variables that may be predictive of economic impact may be dependent on two or more weather conditions/characteristics. For example, average rainfall (shown above) may be predictive of the economic impact due to flooding. However, a combination of the forecasted average rainfall and geological characteristics (e.g., the soil type) in the geographic area of the tropical cyclone path may be more predictive of the economic impact due to flooding. The combination of two or more weather conditions/characteristics may also better capture the climatology of the event, which may be predictive of the long-run economic impact of the forecasted tropical cyclone.

### Characterizing the Forecasted Impact of Forecasted Tropical Cyclones

In addition to the wind speed magnitudes used by current methods, the tropical cyclone analytics system 100 utilizes additional components to better characterize the threat posed by each current and forecasted tropical cyclone.

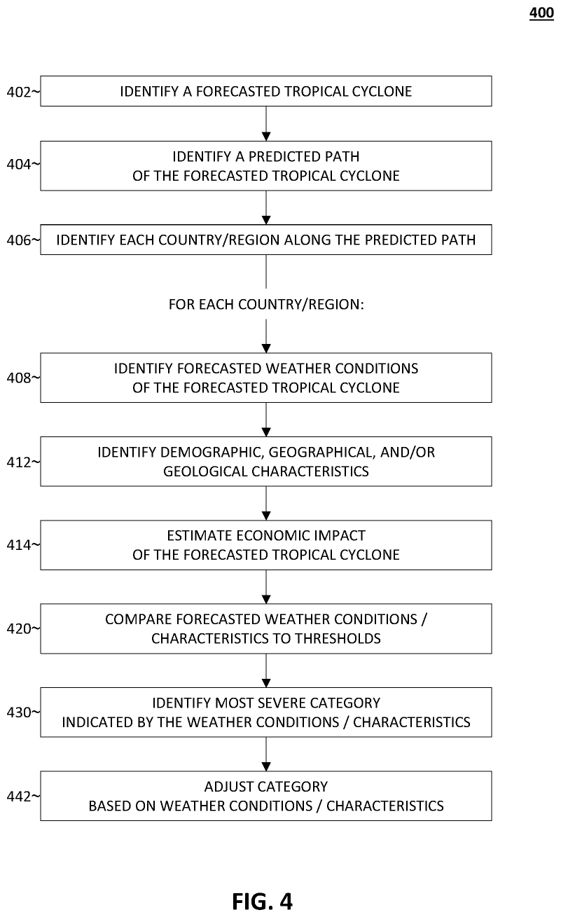

FIG. 4 is a flowchart illustrating a process 400 for characterizing the threat posed by each current or forecasted tropical cyclones according to exemplary embodiments of the present invention. The following description includes identifying forecasted weather conditions (and a predicted path) of a forecasted tropical cyclone. However, as one of ordinary skill in the art would recognize, the same characterization process 400 may be performed to characterize a current tropical cyclone using current weather conditions (and a current path). The characterization process 400 may be performed by the one or more servers 210 executing the analytics engine 180. As described below, some operations included in the characterization process 400 are optional and included in only some of the embodiments of the tropical cyclone analytics system 100. Additionally, as one of ordinary skill in the art would recognize, the operations in the characterization process 400 do not necessarily need to be performed in the order they are shown in FIG. 4 and described below.

A forecasted tropical cyclone is identified in step 402. As mentioned above, the analytics engine 180 may identify the forecasted tropical cyclone by analyzing forecasted weather conditions 116 received by a third party, which may be forecasted using a numerical weather prediction model (or ensemble of models) of the atmosphere and oceans to predict the weather based on current weather conditions.

The predicted path of the forecasted tropical cyclone is identified in step 402. As one of ordinary skill in the art will recognize, the predicted path may be a cone-shaped to represent a probabilistic determination of possible paths of the forecasted tropical cyclone.

Each country/region along the predicted path is identified in step 406. As mentioned above, tropical cyclones are dynamic weather events with characteristics that change as the storm moves along its path. If a tropical cyclone makes landfall in two different regions (or countries) in two different periods during its lifespan, then the same tropical cyclone will cause very different weather conditions (and have very different economic impacts) in those locations. Accordingly, the tropical cyclone analytics system 100 may treat each land mass and/or group of islands as a separate country/region (e.g., the eastern Caribbean, Puerto Rico, Haiti and the Dominican Republic, Cuba, the Bahamas, the mainland United States, etc.) and separately perform the remaining steps of the characterization process 400 for each country/region where the forecasted tropical cyclone is predicted to make landfall. As a result, the tropical cyclone analytics system 100 may characterize the same tropical cyclone as being expected to be two different categories when it makes landfall in two different countries or regions. For example, a tropical cyclone may be expected to be a category 4 hurricane when it makes landfall in the Bahamas and a category 2 hurricane by the time the same storm makes landfall on the mainland United States.

The forecasted weather conditions 116 are identified in step 408. As mentioned above, the forecasted weather conditions 116 may be received by a third party and may be forecasted using a numerical weather prediction model (or ensemble of models) of the atmosphere and oceans to predict the weather based on current weather conditions. If the forecasted tropical cyclone is not predicted to make landfall in the country/region, the tropical cyclone analytics system 100 may identify the forecasted weather conditions that are forecasted to occur in that country/region.

In some embodiments, the demographic (and/or geographical and/or geological) characteristics of the geographic area in the predicted path of the forecasted tropical cyclone are determined in step 412. As mentioned above, the demographic data 124 may include, for example, population density, population age levels, population education levels, income levels, family size, and/or concentrations of real estate sectors (residential, commercial, and industrial) per unit area of the geographic areas in the predicted path of the forecasted tropical cyclone; the geographical data 126 may include, for example, information indicative of the topography, terrain slope, and/or terrain orientation of the geographic area in the predicted path of the forecasted tropical cyclone; and the geological data 128 may include, for example, information indicative of the nature and exposure of bedrock, soil type, soil stability data, and location-specific seismicity of the geographic areas in the predicted path of the forecasted tropical cyclone.

In some embodiments, the economic impact of the forecasted tropical cyclone is estimated in step 414. The predicted economic impact may be estimated by subjectively evaluating the forecasted weather conditions of the forecasted tropical cyclone and the demographic (and other) characteristics of the country/region. In other embodiments, the predicted economic impact may be determined by the analytics engine 180, for example, using the model developed by the analytics engine 180 using the modeling process 300.

In step 420, the forecasted weather conditions 114 of the forecasted tropical cyclone (and, in some embodiments, characteristics of the geographic area in the predicted path) are compared to thresholds (e.g., some of the thresholds identified by the modeling process 300 described above). For example, the tropical cyclone analytics system 100 may compare the forecasted weather conditions 114 of the forecasted tropical cyclone to the following thresholds.

| Category | Avg. Rainfall | Max. Sustained Wind Speed | Storm Surge | Economic Impact | |
|---|---|---|---|---|---|
| <1 | <3 inches | <74 miles per hour | <3 feet | Insignificant impact | |
| 1 | 3-8 inches | 74-95 miles per hour | 3-6 feet | <$10 | billion |
| 2 | 8-15 inches | 96-110 miles per hour | 6-10 feet | $10-39 | billion |
| 3 | 15-22 inches | 111-129 miles per hour | 10-15 feet | $40-99 | billion |
| 4 | 22-30 inches | 130-156 miles per hour | 15-20 feet | $100-199 | billion |
| 5 | >30 inches | >156 miles per hour | >20 feet | $200+ | billion |

As mentioned above with reference to the modeling process 300, some of the thresholds are used to characterize a forecasted tropical cyclone based on a predicted effect that is dependent on two or more weather conditions/characteristics. For example, instead of average rainfall (as shown above), the analytics engine 180 may estimate the predicted flooding, for example based on a combination of the forecasted average rainfall and geological characteristics (e.g., the soil type) in the geographic area of the tropical cyclone path, and compare the predicted flooding to flooding thresholds. In another example, the analytics engine 180 may estimate the people and/or property affected by flooding, for example based on a combination of the forecasted average rainfall, geological characteristics (e.g., the soil type), and demographic data 124 (e.g., population density) in the geographic area of the predicted path of the tropical cyclone. Additionally, the analytics engine 180 may compare the predicted climatology of the event (as determined by two or more characteristics) to climatological thresholds.

In some embodiments, the analytics engine 180 may categorize the forecasted tropical cyclone in step 430 by selecting the highest category indicated by any of the forecasted weather conditions and/or characteristics of the geographic area in the predicted path of the forecasted tropical cyclone. For example, a tropical cyclone that may be categorized as a category 2 on the Saffir-Simpson Hurricane Wind Scale (because the maximum sustained wind speeds are forecasted to be 96-110 miles per hour), but the analytics engine 180 may characterize the same forecasted tropical cyclone as a category 3 storm, for example, if the average rainfall is predicted to be between 15 inches and 22 inches or if the storm surge is predicted to be between 10 feet and 15 feet or if the economic impact is predicted to be between $40 billion and $99 billion.

In other embodiments, the analytics engine 180 may categorize the forecasted tropical cyclone in step 442 by selecting a category based on a single forecasted weather condition (e.g., maximum sustained wind speed, as used in the Saffir-Simpson Hurricane Wind Scale), determine whether the magnitude of one or more additional components (e.g., additional forecasted weather conditions and/or characteristics of the geographic area in the predicted path of the forecasted tropical cyclone) are within certain predetermined ranges, and increase or decrease the characterization by a predetermined amount associated with that additional component. For example, the forecasted tropical cyclone may be initially characterized by selecting a category based on the maximum sustained wind speed as follows:

| Sustained Wind Speed | Category |
|---|---|
| <74 miles per hour | <1 |
| 74-95 miles per hour | 1 |
| 96-110 miles per hour | 2 |
| 111-129 miles per hour | 3 |
| 130-156 miles per hour | 4 |
| >156 miles per hour | 5 |

In those embodiments, one additional component may be current and/or forecasted maximum rainfall per day and the analytics engine 180 may employ the following ranges and adjustments associated with those ranges.

| Maximum Rainfall (in inches, | | |
|---|---|---|
| per day) | | Adjustment |
| <5 | inches / 24 hours | −0.5 |
| >5 < 10 | inches / 24 hours | −0.25 |
| >10 < 15 | inches / 24 hours | 0 |
| >15 < 20 | inches / 24 hours | +0.5 |
| >20 | inches / 24 hours | +1.0 |

Additionally or alternatively, an additional component may be the current and/or forecasted number of days with 10+ inches of rainfall per day and the analytics engine 180 may employ the following ranges and adjustments associated with those ranges.

| Rainfall (Days of 10+ inches/day) | Adjustment |
|---|---|
| <2 days | −0.5 |
| 2-3 days | −0.25 |
| 3-4 days | 0 |
| 4-5 days | +0.5 |
| >5 days | +1.0 |

Additionally or alternatively, an additional component may be the current or forecasted accumulated cyclone energy (ACE) of the tropical cyclone and the analytics engine 180 may employ the following ranges and adjustments associated with those ranges.

| Accumulated Cyclone Energy | Adjustment |
|---|---|
| <40 | −0.5 |
| >40 < 50 | −0.25 |
| >50 < 60 | 0 |
| >60 < 70 | +0.5 |
| >70 | +1.0 |

Additionally or alternatively, an additional component may be the current or forecasted surface pressure of the tropical cyclone and the disclosed system may employ the following ranges and adjustments associated with those ranges.

| Surface Pressure | | Adjustment |
|---|---|---|
| >1,000 | mb | −0.5 |
| >975 < 1,000 | mb | −0.25 |
| >950 < 975 | mb | 0 |
| >925 < 950 | mb | +0.5 |

| | |
|---|---|
| >925 | +1.0 |

Additionally or alternatively, an additional component may be the current or forecasted storm surge of the tropical cyclone and the analytics engine 180 may employ the following ranges and adjustments associated with those ranges.

| Storm Surge | | Adjustment |
|---|---|---|
| <5 | Feet | −0.5 |
| >5 < 10 | Feet | −0.25 |
| >10 < 15 | Feet | 0 |
| >15 < 25 | Feet | +0.5 |
| >25 | Feet | +1.0 |

Additionally or alternatively, an additional component may be the coastal inundation of the geographic area in the forecasted path of the tropical cyclone and the analytics engine 180 may employ the following ranges and adjustments associated with those ranges.

| Coastal Inundation | | Adjustment |
|---|---|---|
| <1 | Mile | −0.5 |
| >1 < 3 | Miles | −0.25 |
| >3 < 5 | Miles | 0 |
| >5 < 10 | Miles | +0.5 |
| >10 | Miles | +1.0 |

Additionally or alternatively, an additional component may be the Melton terrain index of the geographic area in the forecasted path of the tropical cyclone and the analytics engine 180 may employ the following ranges and adjustments associated with those ranges.

| Melton Terrain Index | Adjustment |
|---|---|
| <25 | −0.5 |
| >25 < 35 | −0.25 |
| >35 < 50 | 0 |
| >50 < 75 | +0.5 |
| >75 | +1.0 |

Additionally or alternatively, an additional component may be the soil liquefaction index of the geographic area in the forecasted path of the tropical cyclone.

Additionally or alternatively, additional components may include the manufacturing index and/or infrastructure density of the geographic area in the forecasted path of the tropical cyclone.

Additionally or alternatively, an additional component may be the population density of the geographic area in the forecasted path of the tropical cyclone and the analytics engine 180 may employ the following ranges and adjustments associated with those ranges.

| Population Density | | Adjustment |
|---|---|---|
| <7,500 | people per sq. mile | −0.5 |
| >7,500 < 8,500 | people per sq. mile | −0.25 |
| >8,500 < 10,000 | people per sq. mile | 0 |
| >10,000 < 12,500 | people per sq. mile | +0.5 |
| >12,500 | people per sq. mile | +1.0 |

In alternative embodiments, the tropical cyclone analytics system 100 may store predetermined coefficients associated with each range of each weather condition (or characteristic), compare each forecasted weather condition of the forecasted tropical cyclone (and, optionally, a characteristic of the geographic area in the predicted path of the forecasted tropical cyclone) to the thresholds of each range to identify the relevant coefficients, and multiply an initial characterization of the forecasted tropical cyclone by the relevant coefficients.

Finally, in alternative embodiments, the tropical cyclone analytics system 100 may store predetermined coefficients associated with each weather condition (or characteristic) indicative of the weight of each weather condition (or characteristic) and characterize each forecasted tropical cyclone by multiplying each forecasted weather condition of the forecasted tropical cyclone (and, optionally, characteristic of the geographic area in the predicted path of the forecasted tropical cyclone) by the coefficient associated with that weather condition (or characteristic) indicative of the weight of that weather condition (or characteristic).

The tropical cyclone analytics system 100 may further adjust any adjusted characterization that uses decimals or fractions by rounding (e.g., rounding up, rounding to the nearest integer) or using other rules (e.g., any tropical cyclone with an adjusted characterization equal to or greater than 5 is a category 5) such that the characterizations output by the tropical cyclone analytics system 100 use the same scale (category 1 through category 5) as the Saffir-Simpson Hurricane Wind Scale that consumers are familiar with.

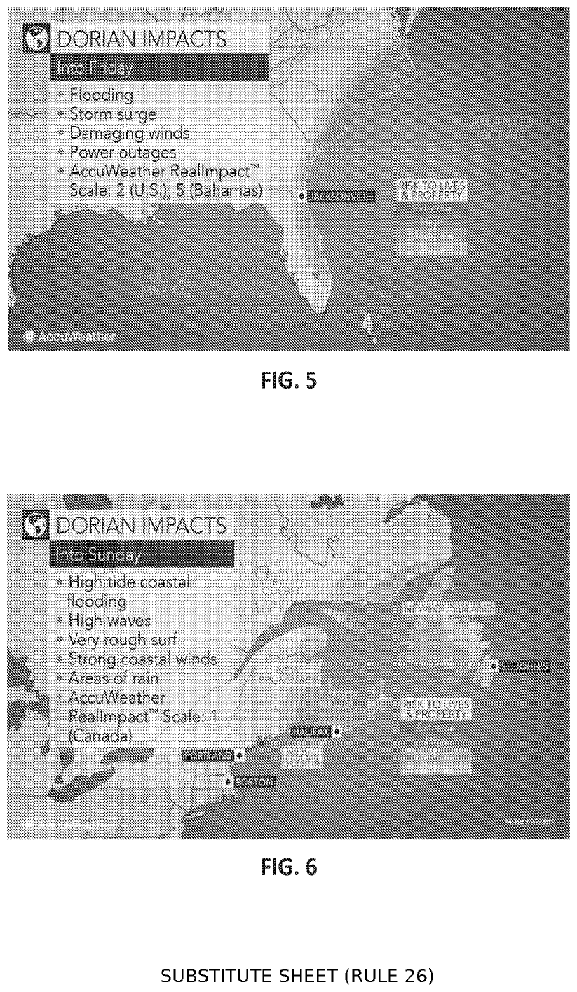

The analytics engine 180 outputs the characterization of the predicted tropical cyclone, for example via the graphical user interface 190, via the one or more networks 230, etc. FIGS. 5 and 6 are views a characterization of a forecasted tropical cyclone output for display to a user.

All of the aforementioned embodiments provide important technical and public safety benefits when compared to the existing method (the Saffir-Simpson Hurricane Wind Scale), which relies only on the forecasted maximum sustained wind speed. By characterizing each tropical cyclone based on multiple forecasted weather conditions 116 (and, in some embodiments, characteristics of the geographic area in the predicted path of the forecasted tropical cyclone), the tropical cyclone analytics system 100 is be able to more accurately predict—and more completely convey—the threat to life and property posed by a forecasted tropical cyclone.

While a preferred embodiment has been set forth above, those skilled in the art who have reviewed the present disclosure will readily appreciate that other embodiments can be realized within the scope of the present invention. Disclosures of specific technologies are also illustrative rather than limiting. Therefore, the present invention should be construed as limited only by the claims.

What is claimed is:

1. A method for forecasting the impact of a forecasted tropical cyclone, the method comprising:
storing a plurality of ranges for each of a plurality of weather conditions;
identifying a forecasted tropical cyclone;
identifying a predicted path of the forecasted tropical cyclone;
identifying each country or region along the predicted path of the forecasted tropical cyclone; and
for each country or region along the predicted path of the forecasted tropical cyclone:
identifying forecasted weather conditions in the country or region attributable to the forecasted tropical cyclone;
comparing the forecasted weather conditions in the country or region to the plurality of ranges for each of the plurality of weather conditions;
characterizing the forecasted tropical cyclone in the country or region based on the comparison of the forecasted weather conditions in the country or region to the plurality of ranges; and
outputting the characterization for display to a user.

2. The method of claim 1, further comprising:
storing a plurality of ranges for a predicted effect of forecasted tropical cyclones;
determining one or more demographic characteristics of the geographic area in the predicted path of the forecasted tropical cyclone;
predicting the effect of the forecasted tropical cyclone in the country or region based on one or more of the forecasted weather conditions attributable to the forecasted tropical cyclone and the one or more demographic characteristics of the geographic area in the predicted path of the forecasted tropical cyclone; and
comparing the predicted effect of the forecasted tropical cyclone in the country or region to the plurality of ranges for a predicted effect,
wherein the characterization of the forecasted tropical cyclone in the country or region is further based on the comparison of the predicted effect of the forecasted tropical cyclone in the country or region to the plurality of ranges for a predicted effect.

3. The method of claim 2, further comprising:
determining one or more geographical characteristics of the geographic area in the predicted path of the forecasted tropical cyclone,
wherein the predicted effect is predicted further based on the one or more geographical characteristics of the geographic area in the predicted path of the forecasted tropical cyclone.

4. The method of claim 2, further comprising:
determining one or more geological characteristics of the geographic area in the predicted path of the forecasted tropical cyclone,
wherein the predicted effect is predicted further based on the one or more geological characteristics of the geographic area in the predicted path of the forecasted tropical cyclone.

5. The method of claim 2, wherein the predicted effect is the predicted economic impact of the forecasted tropical cyclone.

6. The method of claim 5, wherein the predicted economic impact of the forecasted tropical cyclone is estimated by:
identifying the economic impact of past tropical cyclones;
identifying the size of each economy impacted by each of the past tropical cyclones;
scaling the economic impact of based on the size of the impacted economy at the time of each past tropical cyclone;
identifying weather conditions of each of the past tropical cyclones;
determining correlations between the scaled economic impact of each of the past tropical cyclones and the past weather conditions of each of the past tropical cyclones; and
generating a model estimating the economic impact of tropical cyclones based on the correlations between the scaled economic impact of each of the past tropical cyclones and the past weather conditions of each of the past tropical cyclones.

7. The method of claim 6, further comprising:
identifying demographic characteristics of the geographic area affected by each of the past tropical cyclones; and
determining correlations between the scaled economic impact of each of the past tropical cyclones and the demographic characteristics of the geographic area affected by each of the past tropical cyclones,
wherein the model estimating the economic impact of tropical cyclones is generated further based on the correlations between the scaled economic impact of each of the past tropical cyclones and the demographic characteristics of the geographic area affected by each of the past tropical cyclones.

8. The method of claim 6, further comprising:
identifying geographical characteristics of the geographic area of the country or region in the predicted path of the forecasted tropical cyclone;
identifying geographical characteristics of the geographic area affected by each of the past tropical cyclones;
determining correlations between the scaled economic impact of each of the past tropical cyclones and the geographical characteristics of the geographic area affected by each of the past tropical cyclones, wherein:
the model estimating the economic impact of tropical cyclones is generated further based on the correlations between the scaled economic impact of each of the past tropical cyclones and the geographical characteristics of the geographic area affected by each of the past tropical cyclones; and
the estimated economic impact of the forecasted tropical cyclone in the country or region is further based on the geographical characteristics of the geographic area of the country or region in the predicted path of the forecasted tropical cyclone.

9. The method of claim 6, further comprising:
identifying geological characteristics of the geographic area of the country or region in the predicted path of the forecasted tropical cyclone;
identifying geological characteristics of the geographic area affected by each of the past tropical cyclones; and
determining correlations between the scaled economic impact of each of the past tropical cyclones and the geological characteristics of the geographic area affected by each of the past tropical cyclones, wherein:
the model estimating the economic impact of tropical cyclones is generated further based on the correlations between the scaled economic impact of each of the past tropical cyclones and the geological characteristics of the geographic area affected by each of the past tropical cyclones; and
the estimated economic impact of the forecasted tropical cyclone in the country or region is further based on the geological characteristics of the geographic area of the country or region in the predicted path of the forecasted tropical cyclone.

10. The method of claim 1, wherein the comparison of the forecasted weather conditions to the plurality of ranges and the characterization of the forecasted tropical cyclone based on the comparison is performed by a hardware computer processor without human intervention.

11. A system for forecasting the impact of a forecasted tropical cyclone, the system comprising:
one or more databases that store:
a plurality of ranges for each of a plurality of weather conditions; and
forecasted weather conditions, the forecasted weather conditions including a forecasted tropical cyclone and a predicted path of the forecasted tropical cyclone;
one or more servers that:
identify each country or region along the predicted path of the forecasted tropical cyclone; and
for each country or region along the predicted path of the forecasted tropical cyclone:
identify forecasted weather conditions in the country or region attributable to the forecasted tropical cyclone;
compare the forecasted weather conditions in the country or region to the plurality of ranges for each of the plurality of weather conditions;
characterize the forecasted tropical cyclone in the country or region based on the comparison of the forecasted weather conditions in the country or region to the plurality of ranges; and
output the characterization for display to a user.

12. The system of claim 11, wherein:
the one or more databases store a plurality of ranges for a predicted effect of forecasted tropical cyclones; and
the one or more servers are configured to:
determine one or more demographic characteristics of the geographic area in the predicted path of the forecasted tropical cyclone;
predict the effect of the forecasted tropical cyclone in the country or region based on one or more of the forecasted weather conditions attributable to the forecasted tropical cyclone and the one or more demographic characteristics of the geographic area in the predicted path of the forecasted tropical cyclone;
compare the predicted effect of the forecasted tropical cyclone in the country or region to the plurality of ranges for a predicted effect; and
characterize the forecasted tropical cyclone in the country or region further based on the comparison of the predicted effect of the forecasted tropical cyclone in the country or region to the plurality of ranges for a predicted effect.

13. The system of claim 12, wherein the one or more servers are further configured to:
determine one or more geographical characteristics of the geographic area in the predicted path of the forecasted tropical cyclone; and
predict the effect further based on the one or more geographical characteristics of the geographic area in the predicted path of the forecasted tropical cyclone.

14. The system of claim 12, wherein the one or more servers are further configured to:
determine one or more geological characteristics of the geographic area in the predicted path of the forecasted tropical cyclone; and
predicted the effect further based on the one or more geological characteristics of the geographic area in the predicted path of the forecasted tropical cyclone.

15. The system of claim 12, wherein the predicted effect is the predicted economic impact of the forecasted tropical cyclone.

16. The system of claim 15, wherein the one or more servers predict the economic impact of the forecasted tropical cyclone by:
identifying the economic impact of past tropical cyclones;
identifying the size of each economy impacted by each of the past tropical cyclones;
scaling the economic impact of based on the size of the impacted economy at the time of each past tropical cyclone;
identifying weather conditions of each of the past tropical cyclones;
determining correlations between the scaled economic impact of each of the past tropical cyclones and the past weather conditions of each of the past tropical cyclones; and
generating a model estimating the economic impact of tropical cyclones based on the correlations between the scaled economic impact of each of the past tropical cyclones and the past weather conditions of each of the past tropical cyclones.

17. The system of claim 16, wherein the one or more servers are further configured to:
identify demographic characteristics of the geographic area affected by each of the past tropical cyclones;
determine correlations between the scaled economic impact of each of the past tropical cyclones and the demographic characteristics of the geographic area affected by each of the past tropical cyclones; and
generate the model estimating the economic impact of tropical cyclones further based on the correlations between the scaled economic impact of each of the past tropical cyclones and the demographic characteristics of the geographic area affected by each of the past tropical cyclones.

18. The system of claim 16, wherein the one or more servers are further configured to:
identify geographical characteristics of the geographic area of the country or region in the predicted path of the forecasted tropical cyclone;
identify geographical characteristics of the geographic area affected by each of the past tropical cyclones;
determine correlations between the scaled economic impact of each of the past tropical cyclones and the geographical characteristics of the geographic area affected by each of the past tropical cyclones;
generate the model estimating the economic impact of tropical cyclones further based on the correlations between the scaled economic impact of each of the past tropical cyclones and the geographical characteristics of the geographic area affected by each of the past tropical cyclones; and
estimate the economic impact of the forecasted tropical cyclone in the country or region further based on the geographical characteristics of the geographic area of the country or region in the predicted path of the forecasted tropical cyclone.

19. The system of claim 16, wherein the one or more servers are further configured to:
identify geological characteristics of the geographic area of the country or region in the predicted path of the forecasted tropical cyclone;
identify geological characteristics of the geographic area affected by each of the past tropical cyclones;
determine correlations between the scaled economic impact of each of the past tropical cyclones and the geological characteristics of the geographic area affected by each of the past tropical cyclones;
model the economic impact of tropical cyclones is generated further based on the correlations between the scaled economic impact of each of the past tropical cyclones and the geological characteristics of the geographic area affected by each of the past tropical cyclones; and
estimate the economic impact of the forecasted tropical cyclone in the country or region is further based on the geological characteristics of the geographic area of the country or region in the predicted path of the forecasted tropical cyclone.

20. The system of claim 11, wherein the one or more servers compare the forecasted weather conditions to the plurality of ranges and characterize the forecasted tropical cyclone based on the comparison without human intervention.
